(19) United States
(12) Patent Application Publication
(10) Pub. No.: US 2017/0238065 A1
(43) Pub. Date: Aug. 17, 2017

(54) METHOD OF CONTROLLING DEVICE PROVIDING CONTENT, THE DEVICE PROVIDING CONTENT, AND SERVER

(71) Applicant: SAMSUNG ELECTRONICS CO., LTD., Suwon-si (KR)

(72) Inventors: Tae-kwon JANG, Seoul (KR); Sung-jin KIM, Yongin-si (KR); Il-koo KIM, Seongnam-si (KR); Sung-kweon PARK, Suwon-si (KR); Young-o PARK, Seoul (KR); Won-young JANG, Anyang-si (KR); Chang-yeong KIM, Seoul (KR); Joon-hyun LEE, Seoul (KR)

(73) Assignee: SAMSUNG ELECTRONICS CO., LTD., Suwon-si (KR)

(21) Appl. No.: 15/426,642

(22) Filed: Feb. 7, 2017

(30) Foreign Application Priority Data
Feb. 11, 2016 (KR) 10-2016-0015815

(51) Int. Cl. H04N 21/658; H04N 21/2668; H04N 21/8405; H04N 21/25

(52) U.S. Cl. CPC H04N 21/6582; H04N 21/251; H04N 21/2668; H04N 21/8405

(57) ABSTRACT

A method of controlling a device that provides content is provided. The method includes receiving a control signal for controlling at least one item of content provided by the device; in response to receiving the control signal, capturing, at preset intervals, a screen of the device on which content is displayed; in response to the captured screen corresponding to a template screen, extracting content information from a preset area of the captured screen; and identifying the content displayed on the screen of the device, based on the extracted content information.

### CROSS-REFERENCE TO RELATED APPLICATION

This application claims priority from Korean Patent Application No. 10-2016-0015815, filed on Feb. 11, 2016 in the Korean Intellectual Property Office, the disclosure of which is incorporated herein by reference in its entirety.

### BACKGROUND

1. Field

Apparatuses and methods consistent with exemplary embodiments relate to a method of controlling a device that provides content, the device providing content, a non-transitory computer-readable recording medium having recorded thereon a program for executing the method of controlling the device providing content, and a server for controlling the device providing content.

2. Description of the Related Art

In order to produce customized advertisements to satisfy needs of various customers, it may be necessary for an advertisement provider to recognize which content is used by each customer.

According to a fingerprint-based automatic content recognition technique according to the related art, a display device such as a television (TV) captures a characteristic point of video or audio information that is being output by the display device, and transmits the captured characteristic point to a server, and then the server recognizes content information by analyzing the captured characteristic point according to a fingerprint. An advertisement provider may recognize a user-preferred channel or program, based on the recognized content information. Therefore, the advertisement provider may determine a user's preference through the aforementioned procedure, and may produce and provide a customized advertisement.

However, in order for the display device to capture a displayed screen and to transmit the captured screen to the server, there is a hardware load due to, for example, heavy data transmission, etc., on the display device, and there is also an economic burden. Therefore, there is a demand for a technique that enables the display device to rapidly and easily detect required channel information.

### SUMMARY

Exemplary embodiments provide e a method of controlling a device that provides content, the device, and a server, whereby information regarding content being watched by a user of a service may be further efficiently acquired by obtaining the information regarding the content through a captured screen of the device.

According to an aspect of an exemplary embodiment, there is provided a method of controlling a device that provides content, the method including receiving a control signal for controlling at least one item of content provided by the device; in response to receiving the control signal, capturing a screen of the device at preset intervals; in response to the captured screen corresponding to a template screen, extracting content information from a preset area of the captured screen; and identifying content displayed on the screen of the device, based on the extracted content information.

The method may further include determining a service that provides the at least one item of content to the device; and selecting the template screen, according to the determined service.

The preset area of the captured screen may correspond to a content information display area set in the template screen.

The method may further include, in response to the captured screen corresponding to the template screen, stopping the capturing of the screen on which the content is displayed.

The identifying of the content may include obtaining identification information of the content from the extracted content information by comparing the extracted content information with a pre-stored keyword.

The method may further include determining a service that provides the at least one item of content; and determining a type of the control signal, wherein the capturing of the screen comprises capturing the screen on which the content is displayed according to the determined service and the determined type of the control signal.

The control signal may be at least one from among a channel change signal, a power-on signal, a signal for connecting the device with another device, and a signal for requesting information regarding the at least one item of content.

The method may further include transmitting the extracted content information to a server.

The method may further include receiving a content watching pattern of a user of the device from the server, wherein the content watching pattern is determined based on the extracted content information.

According to an aspect of another exemplary embodiment, there is provided a method of providing content information, the method being performed by a server and including: receiving, from at least one device, content information regarding content displayed on the at least one device; determining a content watching pattern of a user of the at least one device, based on the received content information; and providing information regarding the determined content watching pattern to the at least one device, wherein, in response to a screen of the at least one device that corresponds to a template screen being captured, the content information is extracted from the captured screen.

According to an aspect of another exemplary embodiment, there is provided a device that provides content information, the device including: a communication interface configured to receive a control signal for controlling at least one item of content provided by the device; a display configured to display content on the device; and a controller configured to: in response to the communication interface receiving the control signal, capture a screen of the device at preset intervals; and in response to the captured screen corresponding to a template screen, extract content information from a preset area of the captured screen; and identify the content displayed on the display, based on the extracted content information.

The controller may be further configured to: determine a service that provides the at least one item of content to the device, and select the template screen according to the determined service.

The preset area of the captured screen may correspond to a content information display area set in the template screen.

The controller may be further configured to, in response to the captured screen corresponding to the template screen, stop the capturing of the screen on which the content is displayed.

The controller may be further configured to obtain identification information of the content from the extracted content information by comparing the extracted content information with a pre-stored keyword.

The controller may be further configured to: determine a service that provides the at least one item of content; determine a type of the control signal; and capture the screen on which the content is displayed according to the determined service and the determined type of the control signal.

The control signal may be at least one from among a channel change signal, a power-on signal, a signal for connecting the device with another device, and a signal for requesting information regarding the at least one item of content.

The communication interface may be further configured to transmit the extracted content information to a server.

The communication interface may be further configured to receive a content watching pattern of a user of the device from the server, and wherein the content watching pattern is determined based on the extracted content information.

According to an aspect of another exemplary embodiment, there is provided a server that provides content information, the server including: a communication interface configured to receive, from at least one device, content information regarding content displayed on the at least one device; and a controller configured to determine a content watching pattern of a user of the at least one device, based on the content information, wherein the communication interface is further configured to provide information regarding the determined content watching pattern to the at least one device, and in response to a screen of the at least one device that corresponds to a template screen being captured, the content information is extracted from the captured screen.

According to an aspect of another exemplary embodiment, there is provided a non-transitory computer-readable recording medium having recorded thereon a program for executing a method.

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 is a conceptual diagram for describing a method of controlling a device that provides content information, according to an exemplary embodiment;

FIG. 2 is a flowchart of a method of controlling the device that provides content, according to an exemplary embodiment;

FIG. 3 is a flowchart of a method of extracting content information, the method being performed by the device that provides content, according to an exemplary embodiment;

FIGS. 4A, 4B and 4C illustrate template screens provided according to services that provide content;

FIG. 5 is a diagram for describing a method of obtaining content identification information by using content information extracted from a captured screen, the method being performed by the device that provides content, according to an exemplary embodiment;

FIG. 6 is a flowchart of a method of extracting content information from a captured screen according to a type of a received control signal, the method being performed by the device that provides content, according to an exemplary embodiment;

FIG. 7 is a flowchart of a method of extracting content information from a captured screen, the method being performed by the device that provides content, according to another exemplary embodiment;

FIG. 8 is a diagram for describing a method of extracting content information from a captured screen, the method being performed by the device, according to another exemplary embodiment;

FIG. 9 is a flowchart of a method of analyzing a content watching pattern of a user of the device, based on content information received from the device that provides content, the method being performed by a server that controls the device, according to an exemplary embodiment;

FIGS. 10 and 11 are block diagrams of the device that provides content, according to exemplary embodiments; and

FIG. 12 is a block diagram of a server for controlling the device that provides content, according to an exemplary embodiment.

### DETAILED DESCRIPTION

Below, terms that are used in the specification will be briefly described, and exemplary embodiments will be described in detail.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit for processing at least one function or operation, wherein the unit and the block may be embodied as hardware or software or embodied by combining hardware and software.

The disclosure will now be described more fully with reference to the accompanying drawings, in which exemplary embodiments of the disclosure are shown. The disclosure may, however, be embodied in many different forms and should not be construed as being limited to the exemplary embodiments set forth herein; rather, these exemplary embodiments are provided so that this disclosure will be thorough and complete, and will fully convey the concept of the disclosure to those of ordinary skill in the art. In the following description, well-known functions or constructions are not described in detail since they would obscure the disclosure with unnecessary detail. Throughout the specification, like reference numerals in the drawings denote like or similar elements throughout the specification.

As used herein, the term “and/or” includes any and all combinations of one or more of the associated listed items. Expressions such as “at least one of,” when preceding a list of elements, modify the entire list of elements and do not modify the individual elements of the list.

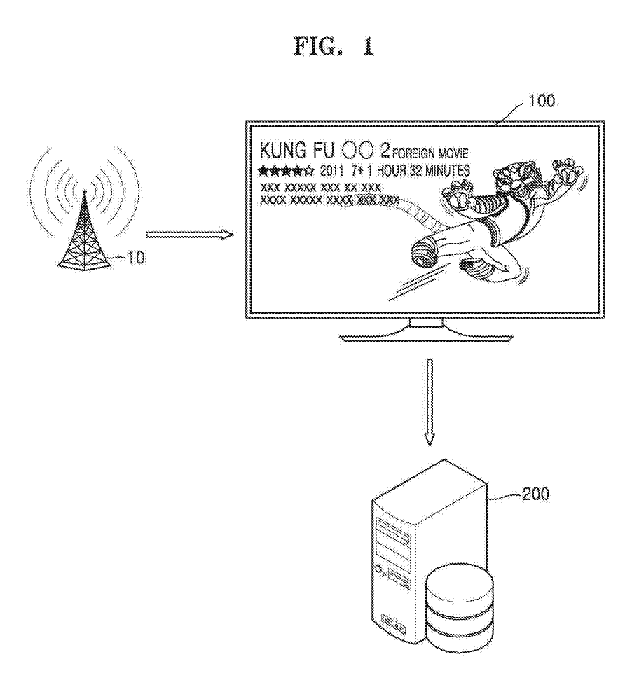

FIG. 1 is a conceptual diagram for describing a method of controlling a device that provides content information 100 (hereinafter, the device 100), according to an exemplary embodiment.

As illustrated in FIG. 1, the device 100 may be a television (TV) but is not limited thereto. The device 100 may be embodied as an electronic device including a display. For example, the device 100 may be embodied as one of various electronic devices including a mobile phone, a tablet personal computer (tablet PC), a digital camera, a camcorder, a laptop computer, a desktop, an electronic-book terminal, a terminal for digital broadcasting, a personal digital assistant (PDA), a portable multimedia player (PMP), a navigation device, an MP3 player, a wearable device, or the like. In particular, exemplary embodiments may be implemented in a display device with a large display such as a TV, but the disclosure is not limited thereto. In addition, the device 100 may be fixed or portable, and may be a digital broadcasting receiver capable of receiving digital broadcasting.

The device 100 according to an exemplary embodiment may receive content from a service providing apparatus 10 that provides at least one item of content. For example, the service providing apparatus 10 may include, but is not limited to, a broadcasting base station, a content providing server, or the like.

The device 100 according to an exemplary embodiment may receive one or more contents from the service providing apparatus 10. The device 100 may display, on a screen of the device 100, content that is selected by a user of the device 100 from among the received one or more contents. For example, the user of the device 100 may transmit a control signal for controlling one or more contents provided by the device 100, to the device 100 through an input device. In this regard, the input device may include, but is not limited thereto, a remote controller, a smart phone, or a wearable device.

When the device 100 according to an exemplary embodiment receives the control signal from the input device, the device 100 may capture the screen of the device 100 on which the content is displayed. For example, when the device 100 receives the control signal, the device 100 may capture, at preset intervals, the screen of the device 100 on which the content is displayed.

The device 100 may determine whether a pre-stored template screen and the captured screen correspond to each other. In this regard, information regarding a text area where information regarding content is displayed on the screen may be preset on the template screen. In addition, the template screen may vary according to types of service that transmits content to the device 100. For example, a template screen of an A service that provides content may be different from a template screen of a B service that provides content.

The device 100 may repeatedly perform an operation of capturing the screen of the device 100 on which the content is displayed, until a screen that corresponds to the template screen is captured. When the screen that corresponds to the template screen is captured, the device 100 may stop the operation of capturing the screen.

The device 100 may extract content information from a preset area of the captured screen corresponding to the template screen. In this regard, the content information may be displayed in the form of texts. The device 100 may extract the content information by recognizing texts displayed on the preset area. For example, the device 100 may read, by using an optical character reader (OCR), the texts on the preset area of the captured screen, and may extract information regarding a type, a title, and a genre of the content.

The device 100 may transmit the extracted content information to a server 200. The server 200 according to an exemplary embodiment may recognize the content being watched by the user of the device 100, based on the content information extracted by the device 100. In addition, the server 200 may analyze a content watching pattern of the user of the device 100, by using the received content information. In this regard, the content watching pattern of the user may be used by the server 200 to determine information regarding content preferred by the user of the device 100.

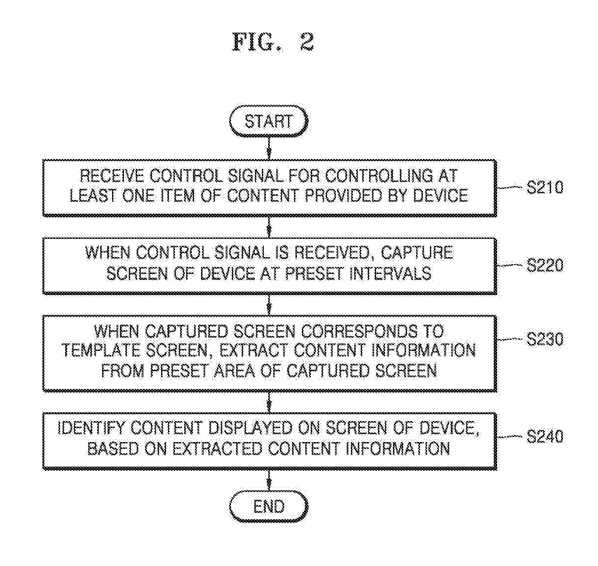

FIG. 2 is a flowchart of a method of controlling the device 100 that provides content, according to an exemplary embodiment.

In operation S210, the device 100 receives a control signal for controlling at least one item of content provided by the device 100.

The device 100 according to an exemplary embodiment may receive, from an input device, the control signal for controlling at least one item of content provided by the device 100. For example, the device 100 may receive, from a remote controller, the control signal for controlling at least one item of content provided by the device 100. In this regard, the control signal may be one of a channel change signal with respect to the device 100, a power-on signal with respect to the device 100, a signal for connecting the device 100 with another device, a menu selection signal with respect to the device 100, and a signal for requesting at least one piece of content information.

In operation S220, when the device 100 receives the control signal, the device 100 captures a screen of the device 100 at preset intervals.

When the device 100 according to an exemplary embodiment receives the control signal, the device 100 may capture the screen of the device 100 on which the content is displayed. In this regard, at least one of a menu for selecting at least one item of content provided by the device 100, content identification information, and content may be displayed on the screen of the device 100. However, the disclosure is not limited to an exemplary embodiment, and thus, information displayed on the screen of the device 100 is not limited thereto.

In addition, the device 100 according to an exemplary embodiment may repeatedly capture the screen of the device 100 at preset intervals. For example, the device 100 may capture the screen of the device 100 at intervals of two seconds from a point of time when the device 100 receives the control signal.

In operation S230, when the captured screen corresponds to a template screen, the device 100 extracts content information from a preset area of the captured screen. In this regard, the template screen may vary according to types of service that provides at least one item of content to the device 100. For example, in a case of a template screen with respect to an A service, information indicating an area to display content information may be preset on an upper left area of a screen.

When a screen of the device 100 which corresponds to the template screen is captured, the device 100 according to an exemplary embodiment may stop an operation of capturing the screen. The screen that corresponds to the template screen may be a screen on which at least one of an image and a text is displayed at a position corresponding to a position of at least one of an image and a text displayed on the template screen. For example, when a screen on which a text is displayed at a position corresponding to a position on a preset area of the template screen is captured, the device 100 may stop the operation of capturing the screen.

The device 100 according to an exemplary embodiment may extract content information displayed on a preset area of the captured screen corresponding to the template screen.

In operation S240, the device 100 may identify content displayed on the screen of the device 100, based on the extracted content information.

For example, the device 100 may read, by using the OCR, a text displayed on the extracted content information. In this regard, the content information may include, but is not limited to, information regarding a title, a type, and a genre of the content.

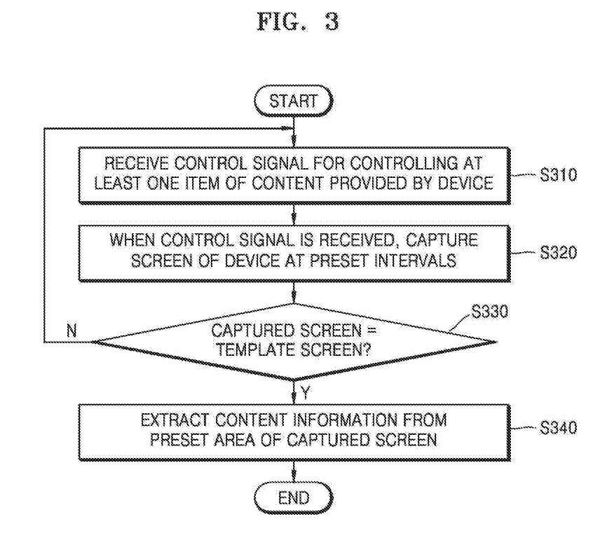

FIG. 3 is a flowchart of a method of extracting content information, the method being performed by the device 100 that provides content, according to an exemplary embodiment.

In operation S310, the device 100 may receive a control signal for controlling at least one item of content provided by the device 100.

Operation S310 may correspond to operation S210 described above with reference to FIG. 2.

In operation S320, when the device 100 receives the control signal, the device 100 may capture, at preset intervals, a screen of the device 100 on which the content is displayed.

In operation S330, the device 100 may determine whether the captured screen corresponds to a template screen. In this regard, the template screen may be selected according to types of service that provides at least one item of content to the device 100.

The device 100 according to an exemplary embodiment may identify a type of the service by using the received control signal. For example, when the device 100 receives a signal of an infrared (IR) type set-top remote controller, the device 100 may identify a set-top box that provides a service, by using the signal of the set-top remote controller.

According to another exemplary embodiment, the device 100 may identify the type of the service that provides at least one item of content to the device 100, according to pre-stored information regarding a user interface (UI) layout of each service. When it is difficult for the device 100 to analyze the control signal, the device 100 may compare the pre-stored information regarding the UI layout of each service with a UI layout of the content, and may identify the type of the service. For example, when the control signal received by the device 100 is a signal of a Bluetooth-type set-top remote controller, it may be difficult for the device 100 to analyze the control signal. Therefore, the device 100 may identify the type of the service that provides the content to the device 100, according to the pre-stored information regarding the UI layout of each service.

According to another exemplary embodiment, when the device 100 does not receive a signal of a set-top remote controller but receives a signal of a TV remote controller, the device 100 may determine the service, which provides the content to the device 100, to be terrestrial TV broadcasting or a service application.

When the device 100 according to an exemplary embodiment identifies the type of the service, the device 100 may select a template screen that corresponds to the identified type of the service. The device 100 according to an exemplary embodiment may repeatedly capture a screen of the device 100 until the device 100 captures a screen of the device 100 on which a text on a preset area of the template screen is displayed.

In operation S340, the device 100 may extract content information from a preset area of the captured screen.

When the captured screen corresponds to the template screen, the device 100 according to an exemplary embodiment may extract the content information from the preset area of the captured screen. For example, the device 100 may extract the text on an area from the captured screen, the area corresponding to a preset content information display area of the template screen.

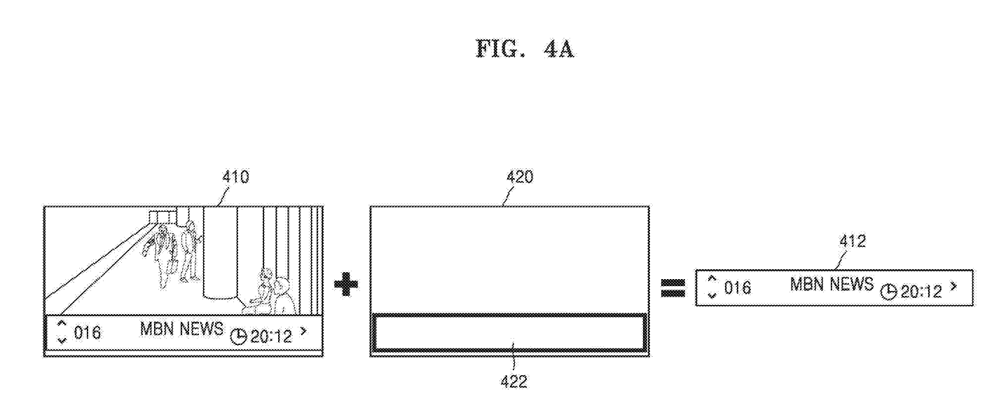

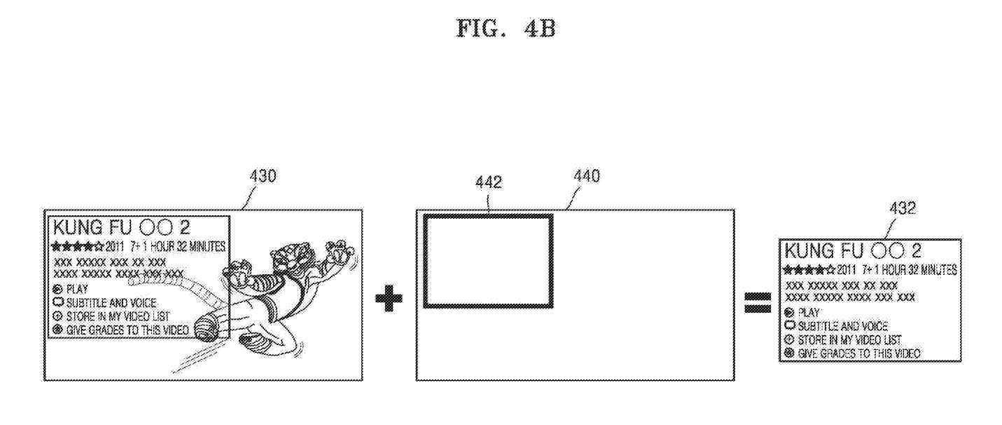

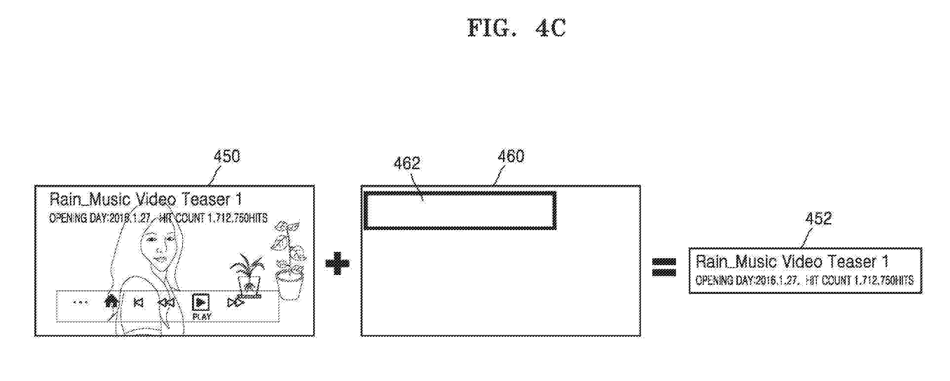

FIGS. 4A through 4C illustrate template screens provided according to services that provide content.

Referring to FIG. 4A, when the device 100 that provides content receives a control signal from an input device, the device 100 may capture a screen of the device 100 at preset intervals until a screen 410 corresponding to a template screen 420 is captured. In this regard, the device 100 may select the template screen 420 that is pre-stored with respect to an A service that provides content. In addition, a content information display area 422 where information regarding content is displayed may be preset on the template screen 420 selected by the device 100. For example, the device 100 may capture the screen at preset intervals until a screen of which area displays a text 412, the area corresponding to the content information display area 422, is captured.

The device 100 according to an exemplary embodiment may extract the text 412 from a bottom area of the captured screen 410 which corresponds to the content information display area 422. Also, the device 100 may identify the content displayed on the device 100 by reading the extracted text 412.

Referring to FIG. 4B, when the device 100 receives an input signal from an input device, the device 100 may capture, at preset intervals, a screen 430 of the device 100 which corresponds to a template screen 440. In this regard, the device 100 may select a template screen 430 that is pre-stored with respect to a B service that provides content. In addition, a content information display area 442 where information regarding content is displayed may be preset on the template screen 430 selected by the device 100. For example, the device 100 may capture a screen of the device 100 at preset intervals until the screen of which area displays a text 432, the area corresponding to the content information display area 442, is captured.

The device 100 according to an exemplary embodiment may extract the text 432 from an upper left area of the captured screen 430 which corresponds to the content information display area 442. Also, the device 100 may identify the content displayed on the device 100 by reading the extracted text 432.

Referring to FIG. 4C, when the device 100 receives an input signal from an input device, the device 100 may capture, at preset intervals, a screen of the device 100 until the device 100 captures a screen 450 that corresponds to a template screen 460. In this regard, the device 100 may select a template screen 450 that is pre-stored with respect to a C service that provides content. In addition, a content information display area 462 where information regarding content is displayed may be preset on the template screen 450 selected by the device 100. For example, the device 100 may capture a screen of the device 100 at preset intervals until the screen of which area displays a text 452, the area corresponding to the content information display area 462, is captured.

The device 100 according to an exemplary embodiment may extract the text 462 from an upper left area of the captured screen 450 which corresponds to the content information display area 462. Also, the device 100 may identify the content displayed on the device 100 by reading the extracted text 462.

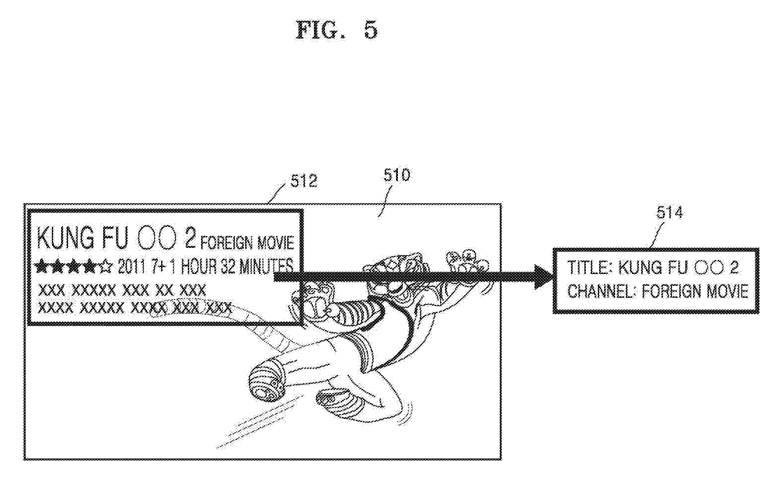

FIG. 5 is a diagram for describing a method of obtaining content identification information 514 by using content information 512 extracted from a captured screen 510, the method being performed by the device 100 that provides content, according to an exemplary embodiment.

Referring to FIG. 5, the device 100 according to an exemplary embodiment may extract the content information 512 from the captured screen 510 that corresponds to a template screen. Also, the device 100 may identify texts indicating information regarding content by reading the extracted content information 512.

The device 100 according to an exemplary embodiment may compare a preset keyword with the texts indicating the information regarding the content, and may obtain the content identification information 514 regarding a title of the content and a channel that provides the content.

While the device 100 according to an exemplary embodiment identifies the texts from the information regarding the content, when some text of the texts is determined as a typographical error, the device 100 may correct the typographical error by using a preset keyword. For example, when a text is read as ‘Kung Fi OO’, the device 100 may correct the read text to be ‘Kung Fu OO’ by using a preset keyword. In this manner, since the device 100 uses the preset keyword, the device 100 may further exactly obtain the content identification information 514 from the texts indicating the information regarding the content.

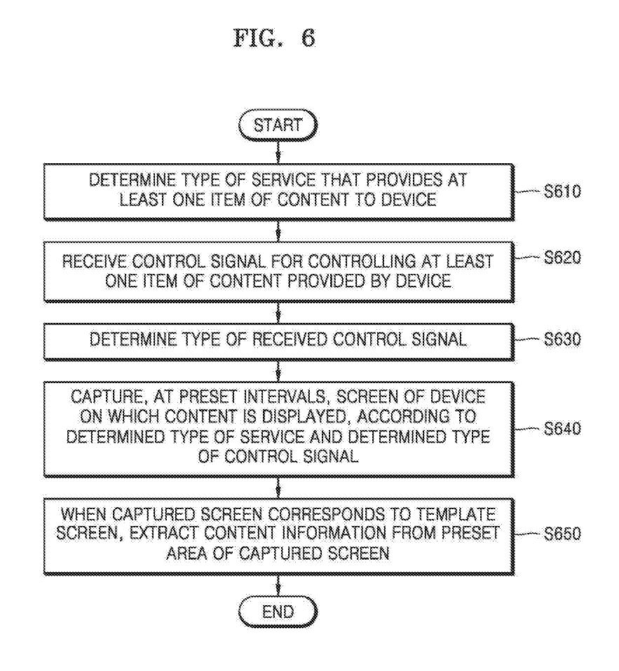

FIG. 6 is a flowchart of a method of extracting content information from a captured screen according to a type of a received control signal, the method being performed by the device 100 that provides content, according to an exemplary embodiment.

In operation S610, the device 100 may determine a type of a service that provides at least one item of content to the device 100. In this regard, the service may be, but is not limited to, one of a video on demand (VOD) service, a live service, and an application-based service, and a type of the service providing at least one item of content is not limited.

In operation S620, the device 100 may receive a control signal for controlling the at least one item of content provided by the device 100.

Operation S610 may correspond to operation S210 described above with reference to FIG. 2.

In operation S630, the device 100 may determine a type of the received control signal.

The device 100 according to an exemplary embodiment may determine whether the received control signal corresponds to one of a channel change signal with respect to the device 100, a power-on signal with respect to the device 100, a signal for connecting another device to the device 100, a menu selection signal with respect to the device 100, and a signal for requesting information regarding the at least one item of content.

In operation S640, the device 100 may capture, at preset intervals, a screen of the device 100 on which the content is displayed, according to the determined type of the service and the determined type of the control signal.

When a control signal of which type is preset according to each service is received, the device 100 according to an exemplary embodiment may capture the screen of the device 100. For example, in a case of the VOD service, when the device 100 receives a control signal for moving a menu displayed on the device 100 in up and down-right and left directions or a control signal for selecting a particular menu, the device 100 may capture the screen of the device 100 at preset intervals. As another example, in a case of the live service, when a signal for changing a channel of the device 100 is received, the device 100 may capture the screen of the device 100 at preset intervals. As another example, in a case of the application-based service, when the device 100 receives a control signal for moving a menu displayed on the device 100 in up and down-right and left directions or a control signal for selecting a particular menu, the device 100 may capture the screen of the device 100 at preset intervals.

In operation S650, when the captured screen corresponds to a template screen, the device 100 may extract content information from a preset area of the captured screen.

When the captured screen corresponds to the template screen, the device 100 according to an exemplary embodiment may extract the content information displayed on an area of the captured screen, the area corresponding to a content information display area of the template screen. In this regard, the content information may be in the form of texts. The device 100 may recognize texts by reading the content information.

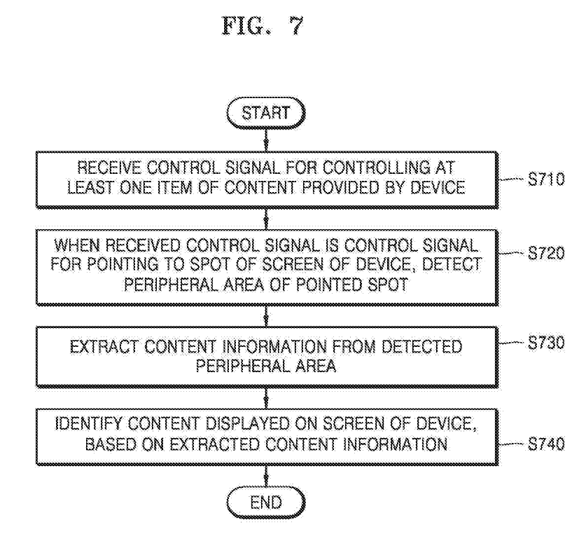

FIG. 7 is a flowchart of a method of extracting content information from a captured screen, the method being performed by the device 100 that provides content, according to another exemplary embodiment.

In operation S710, the device 100 may receive a control signal for controlling at least one item of content provided by the device 100. For example, the device 100 may receive, from an input device such as a remote controller, the control signal for controlling at least one item of content provided by the device 100.

In operation S720, when the received control signal is a control signal for pointing to a spot of a screen of the device 100, the device 100 may detect a peripheral area of the pointed spot.

The device 100 according to an exemplary embodiment may determine whether the received control signal is the control signal for pointing to the spot of the screen of the device 100. When the device 100 determines that the received control signal is the control signal for pointing to the spot of the screen of the device 100, the device 100 may detect a peripheral area within a preset range from the pointed spot.

In operation S730, the device 100 may extract content information from the detected peripheral area.

The device 100 according to an exemplary embodiment may determine the content information extracted from the detected peripheral area. In addition, the device 100 may extract a text indicating information regarding content by reading the extracted content information.

In operation S740, the device 100 may identify the content displayed on the screen of the device 100, based on the extracted content information.

The device 100 according to an exemplary embodiment may read the text displayed on the extracted content information, by using a text reading technique such as the OCR. However, a method of identifying content according to content information extracted by the device 100 is not limited to an exemplary embodiment.

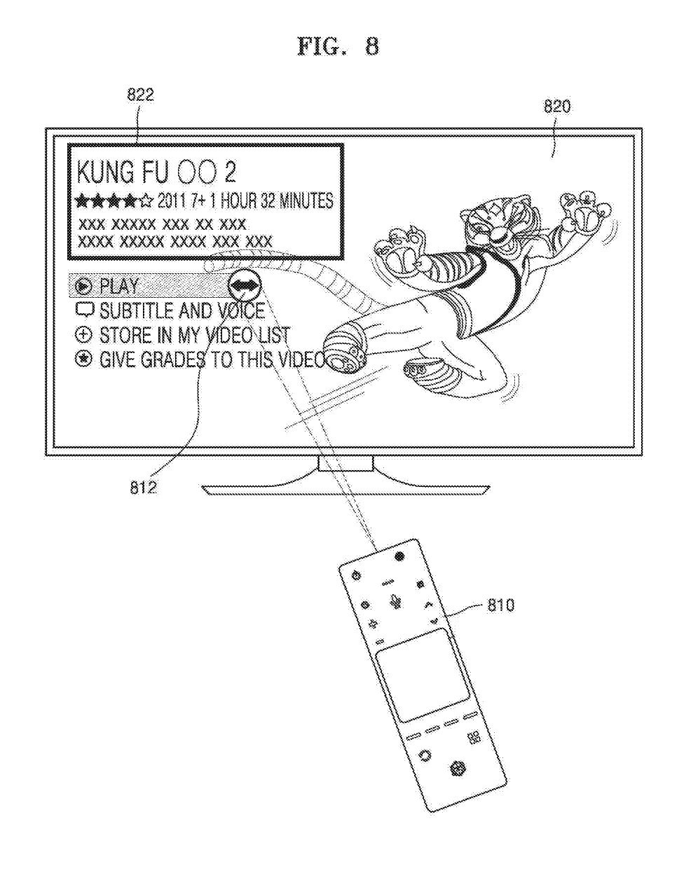

FIG. 8 is a diagram for describing a method of extracting content information from a captured screen, the method being performed by the device 100, according to another exemplary embodiment.

Referring to FIG. 8, the device 100 according to an exemplary embodiment may receive, from an input device 810, a control signal 812 for controlling at least one item of content provided by the device 100. When the received control signal 812 is a control signal for pointing to a spot of a screen 8200 of the device 100, the device 100 may detect a peripheral area 822 of the pointed spot.

The device 100 according to an exemplary embodiment may determine whether the received control signal 812 is the control signal for pointing to the spot of the screen of the device 100. When the device 100 determines that the received control signal 812 is the control signal for pointing to the spot of the screen of the device 100, the device 100 may detect the peripheral area 822 within a preset range from the pointed spot.

The device 100 according to an exemplary embodiment may identify a text indicating information regarding the content by reading content information extracted from the detected peripheral area 822. For example, the device 100 may recognize a title of the content as ‘Kung Fu OO 2’ by identifying the text indicating the information regarding the content.

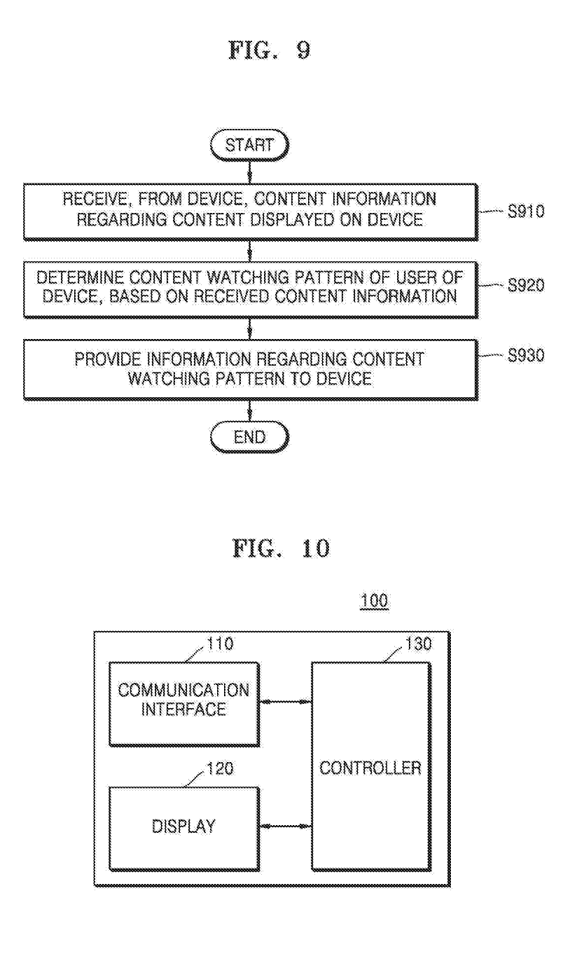

FIG. 9 is a flowchart of a method of analyzing a content watching pattern of a user of the device 100, based on content information received from the device 100 that provides content, the method being performed by a server 200 that controls the device 100, according to an exemplary embodiment.

In operation S910, the server 200 receives, from the device 100, content information regarding content displayed on the device 100.

When a screen of the device 100 which corresponds to a template screen is captured by the device 100, the server 200 according to an exemplary embodiment may receive content information extracted from the captured screen from the device 100. For example, the server 200 may receive, from the device 100, information regarding a genre of the content displayed on the device 100, a title of the content, and a channel that provides the content.

In operation S920, the server 200 determines a content watching pattern of the user of the device 100, based on the received content information.

The server 200 according to an exemplary embodiment may store the received content information. The server 200 may determine the content watching pattern of the user of the device 100 by using a plurality of pieces of content information stored during a preset period. In this regard, the content watching pattern may be used in determining a genre of user-preferred content, a user-preferred channel, or the like. For example, the device 100 may determine the genre of the user-preferred content by determining content by using the stored content information, wherein the content has been watched most frequently by the user during the preset period.

In operation S930, the server 200 provides information regarding the content watching pattern to the device 100.

When the content watching pattern is determined, the server 200 according to an exemplary embodiment may provide the information regarding the content watching pattern to the device 100. When the device 100 receives the information regarding the content watching pattern from the server 200, the device 100 may generate a recommended contents list or the like, based on the information regarding the content watching pattern.

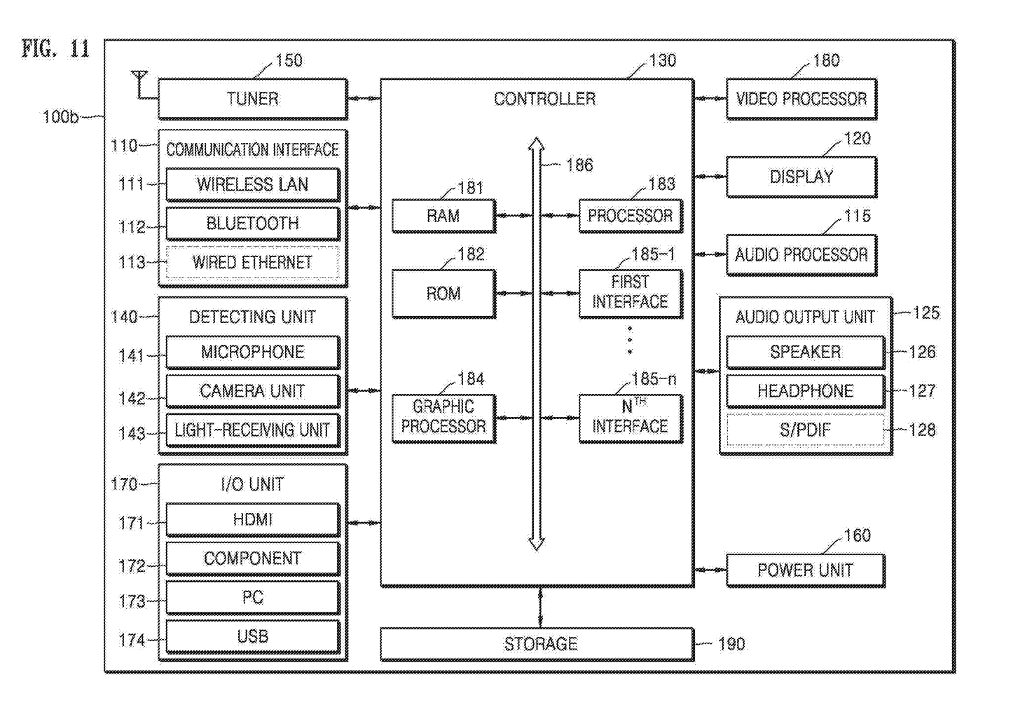

FIGS. 10 and 11 are block diagrams of the device 100 that provides content, according to one or more exemplary embodiments.

Referring to FIG. 10, the device 100 according to an exemplary embodiment may include a communication interface 110, a controller 130, and a display 120. However, not all elements shown in FIG. 10 are necessary elements of the device 100. That is, the device 100 may be embodied with more or less elements than the elements shown in FIG. 10.

For example, as illustrated in FIG. 11, the device 100 according to an exemplary embodiment may further include, in addition to the communication interface 110, the controller 130, and the display 120, an audio processor 115, an audio output unit 125, a detecting unit 140, a tuner 150, a power unit 160, an input/output (I/O) unit 170, a video processor 180, and a storage 190 (e.g., memory).

Hereinafter, the elements are described in order below.

The communication interface 110, by control of the controller 130, may connect the device 100 with an external device (e.g., an input device, a service providing apparatus, a server, etc). The controller 130 may exchange content with the service providing apparatus connected through the communication interface 110, may download an application from the service providing apparatus, or may perform web browsing by using the communication interface 110. The communication interface 110 may include one of a wireless local area network (LAN) 111, Bluetooth 112, and a wired Ethernet 113 so as to correspond to performance and a structure of the device 100. Also, the communication interface 110 may include a combination of the wireless LAN 111, the Bluetooth 112, and the wired Ethernet 113. The communication interface 110 may receive, by control of the controller 130, a control signal from the input device. The control signal may be implemented as one of a Bluetooth-type control signal, a radio frequency (RF)-type control signal, and a WiFi-type control signal.

The communication interface 110 may further include other short-range communication such as near field communication (NFC), Bluetooth low energy (BLE), or the like, other than Bluetooth.

The communication interface 110 according to an exemplary embodiment receives a control signal for controlling at least one item of content provided by the device 100. In this case, the communication interface 110 may perform functions corresponding to those of the detecting unit 140.

The communication interface 110 may transmit extracted content information to the server 200. In addition, the communication interface 110 may receive, from the server 200, content watching pattern information of a user of the device 100 which is determined based on the extracted content information.

The display 120 generates a driving signal by converting a video signal, a data signal, an on-screen display (OSD) signal, a control signal, or the like which are processed by the controller 130. The display 120 may be embodied as one of a plasma display panel (PDP), a liquid crystal display (LCD), an organic light-emitting display (OLED), a flexible display, or the like, and may also be embodied as a three-dimensional (3D) display. The display 120 may be configured as a touch screen to be used as both an output device and an input device.

The display 120 according to an exemplary embodiment displays content. The display 120 may correspond to a display screen since the display 120 displays the content.

The controller 130 generally controls all operations of the device 100. For example, the controller 130 may generally control the communication interface 110, the display 120, the audio processor 115, the audio output unit 125, the detecting unit 140, the tuner 150, the power unit 160, the I/O unit 170, the video processor 180, and the storage 190 by executing programs stored in the storage 190.

When the controller 130 according to an exemplary embodiment receives the control signal, the controller 130 captures a screen of the device 100 at preset intervals. When the captured screen corresponds to a template screen, the controller 130 extracts content information from a preset area of the captured screen. The controller 130 identifies the content displayed on the display 120, based on the extracted content information.

The controller 130 according to an exemplary embodiment may determine a type of a service that provides the at least one item of content. The controller 130 may select a template screen, according to the determined type of the service.

When the captured screen corresponds to the template screen, the controller 130 according to an exemplary embodiment may stop capturing the screen on which the content is displayed. The controller 130 may determine the type of the service and the type of the control signal. According to the determined type of the service and the determined type of the control signal, the controller 130 may capture, at preset intervals, the screen of the device 100 on which the content is displayed

The controller 130 according to another exemplary embodiment may determine whether the received control signal is a signal for pointing to a spot of the screen of the device 100, and may detect a preset area from the spot pointed at the screen. The controller 130 may extract information regarding the content from the detected area. The controller 130 may identify the content displayed on the display 120, based on the extracted content information.

The audio processor 115 may process audio data. The audio processor 115 may perform various processing such as decoding, amplification, noise filtering, or the like on the audio data. The audio processor 115 may include a plurality of audio processing modules so as to process a plurality of pieces of audio data corresponding to a plurality of pieces of content.

The audio output unit 125 outputs, by control of the controller 130, audio included in a broadcasting signal that is received by the tuner 150. The audio output unit 125 may output audio (e.g., music or a sound) that is input via the communication interface 110 or the I/O unit 170. Also, the audio output unit 125 may output, by control of the controller 130, audio stored in the storage 190. The audio output unit 125 may include at least one of a speaker 126, a headphone output terminal 127, and a Sony/Philips Digital Interface Format (S/PDIF) output terminal 128. The audio output unit 125 may include a combination of the speaker 126, the headphone output terminal 127, and the S/PDIF output terminal 128.

The detecting unit 140 according to an exemplary embodiment may detect a user input and may transmit a detected signal to the controller 130. In addition, the detecting unit 140 may detect a user input for turning power on or off, selecting a channel, going up or down channels, or setting the screen. The detecting unit 140 according to an exemplary embodiment may detect a user input for moving a cursor displayed on the display 120 and a direction key input for moving a focus among candidate items. In addition, the detecting unit 140 may detect a user's voice, a user's image, or interaction of the user.

A microphone 141 receives an uttered voice of the user. The microphone 141 may convert the received voice into an electrical signal and may output the electrical signal to the controller 130.

The microphone 141 may be integrally formed with the device 100 or may be separately formed from the device 100. The separately-formed microphone 141 may be electrically connected to the device 100 via the communication interface 110 or the I/O unit 170. It will be obvious to one of ordinary skill in the art that the microphone 141 may not be used according to performance and a structure of the device 100.

A camera unit 142 may convert, by control of the controller 130, a received image into an electrical signal and may output the electrical signal to the controller 130.

A light-receiving unit 143 receives an optical signal (including a control signal) from an external input device through a light-receiving window of a bezel of the display 120. The light-receiving unit 143 may receive an optical signal corresponding to a user input (e.g., a touch, a press, a touch gesture, a voice, or a motion) from the external input device. The control signal may be extracted from the optical signal by control of the controller 130.

The tuner 150 may tune and select a frequency of a channel that a user wants to receive via the device 100, wherein the frequency is obtained by tuning, via amplification, mixing, and resonance, frequency components of a broadcasting signal that is received in a wired or wireless manner. The broadcasting signal includes an audio signal, a video signal, and additional information (e.g., an electronic program guide (EPG)).

The tuner 150 may receive a broadcasting signal in a frequency band corresponding to a channel number (e.g., a cable broadcasting channel no. 506), according to a user input. The broadcasting signal may be, for example, a control signal broadcast from a control apparatus, e.g., input of a channel number, a channel up or down input, or a channel selection via an EPG screen.

The tuner 150 may receive a broadcasting signal from various sources including ground wave broadcasting, cable broadcasting, satellite broadcasting, internet broadcasting, or the like. The tuner 150 may also receive a broadcasting signal from a source such as analog broadcasting or digital broadcasting. The broadcasting signal received by the tuner 150 is decoded (e.g., audio decoding, video decoding, or additional information decoding) and is split into audio, video, and/or additional information. The split audio, video, and/or additional information may be stored in the storage 190 by control of the controller 130.

The power unit 160 supplies, by control of the controller 130, power, which is input from an external power source, to internal elements of the device 100. Also, the power unit 160 may supply, by control of the controller 130, power to the internal elements of the device 100, wherein the power is output from one or more batteries arranged in the device 100.

The I/O unit 170 receives, by control of the controller 130, video (e.g., a moving picture, etc.), audio (e.g., a voice, music, etc.), and additional information (e.g., an EPG, etc.) from an external source of the device 100. The I/O unit 170 may include one of a high-definition multimedia interface (HDMI) port 171, a component jack 172, a PC port 173, and a universal serial bus (USB) port 174. The I/O unit 170 may include a combination of the HDMI port 171, the component jack 172, the PC port 173, and the USB port 174.

It will be obvious to one of ordinary skill in the art that a configuration and operations of the I/O unit 170 may vary in the one or more exemplary embodiments.

The video processor 180 may process video data received by the device 100. The video processor 180 may perform various image processing such as decoding, scaling, noise filtering, frame rate conversion, resolution conversion, or the like on the video data.

The controller 130 may include a random-access memory (RAM) 181 used to store a signal or data received from an external source of the device 100 or used as a storage domain for various tasks that are performed in the device 100, a read-only memory (ROM) 182 that stores a control program for controlling the device 100, and a processor 183.

The processor 183 may include a graphic processing unit (GPU) for processing graphics that correspond to a video. The processor 183 may be embodied as a System on Chip (SoC) including a core and the GPU. The processor 183 may include a single core, a dual-core, a triple-core, a quad-core, or a multi-core.

The processor 183 may include a plurality of processors. For example, the processor 183 may be embodied as a main processor and a sub-processor that operates during a sleep mode.

A graphic processor 184 generates a screen including various objects such as an icon, an image, a text, or the like, by using a calculation unit and a rendering unit. The calculation unit calculates coordinate values of the objects that are to be displayed according to a layout of a screen by using a user input detected by the detecting unit 140, and calculates attribute values of shapes, sizes, or colors of the objects. Then, the rendering unit may generate screens with various layouts including the objects based on the attribute values calculated by the calculation unit. The screen generated by the rendering unit may be displayed in regions of the display 120.

First through n^{th} interfaces 185-1 through 185-n are connected to the aforementioned elements. One of the first through n^{th} interfaces 185-1 through 185-n may function as a network interface that is connected to an external device via a network.

The RAM 181, the ROM 182, the processor 183, the graphic processor 184, and the first through n^{th} interfaces 185-1 through 185-n may be connected to each other via an internal bus 186.

According to one or more exemplary embodiments, the term “controller” may include the processor 183, the ROM 182, and the RAM 181.

The storage 190 may store, by control of the controller 130, various data, programs, or applications for driving and controlling the device 100. For example, the storage 190 may store a control program for a control operation by the device 100 or the controller 130, an application that is originally provided by a manufacturer or is downloaded from an external source, a graphical user interface (GUI) related to the application, an object (e.g., an image text, an icon, a button, etc.) for providing the GUI, user information, documents, databases, or related data.

In an exemplary embodiment, the term “storage unit” includes the storage 190, the ROM 182 and the RAM 181 of the controller 130, or a memory card (e.g., a micro secure digital (SD) card or a USB memory) mounted to the device 100. Also, the storage 190 may include a non-volatile memory, a volatile memory, a hard disk drive (HDD), or a solid-state drive (SSD).

The storage 190 (e.g., memory) may include a broadcasting receiving module, a channel control module, a volume control module, a communication control module, a voice recognition module, a motion recognition module, a light-receiving module, a display control module, an audio control module, an external input control module, a power control module, a voice database, or a motion database. The aforementioned modules and databases of the storage 190 may be implemented as a plurality of pieces of software for performing a broadcasting reception control function, a channel control function, a volume control function, a communication control function, a voice recognition function, a motion recognition function, a light-receiving control function, a display control function, an audio control function, an external input control function, a power control function, or a power control function of the other external apparatus so as to control power of the other external apparatus that is connected in a wireless manner (e.g., Bluetooth). The controller 130 may perform the aforementioned functions by using the plurality of pieces of software, respectively, which are stored in the storage 190.

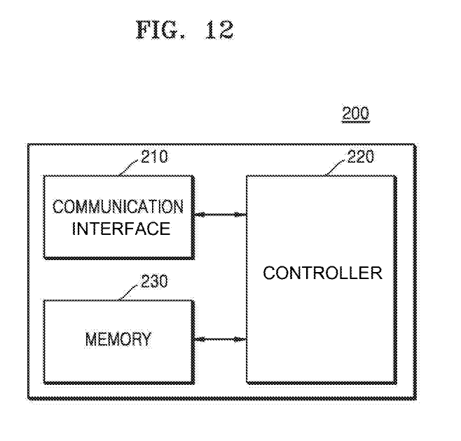

FIG. 12 is a block diagram of the server 200 that receives content information from the device 100, according to an exemplary embodiment.

Referring to FIG. 12, the server 200 according to an exemplary embodiment may include a communication interface 210, a controller 220, and a memory 230. However, not all elements shown in FIG. 12 are necessary elements of the server 200. That is, the server 200 may be embodied with more or less elements than the elements shown in FIG. 12.

The communication interface 210 receives, from at least one device, content information regarding content displayed on the at least one device. In addition, the communication interface 210 provides information regarding determined content watching pattern to the at least one device.

The controller 220 determines content watching pattern of a user of the at least one device, based on the received content information. In this regard, when a screen of the at least one device which corresponds to a template screen is captured, the content information may be extracted from the captured screen.

The memory 230 may store a program for processing and controlling the controller 220, and may store a plurality of pieces of data that are input to or output from the server 200.

The memory 230 may include a storage medium of at least one type selected from a flash memory, a hard disk, a multimedia card type memory, a card type memory such as a secure digital (SD) or xD-Picture (xD) card memory, a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc. The device 100 may run web storage or a cloud server that performs a storage function of the memory 230 on the Internet.

The methods according to one or more exemplary embodiments can be embodied as programmed commands to be executed in various computer means, and then can be recorded to a non-transitory computer-readable recording medium. The non-transitory computer readable recording medium may include one or more of the programmed commands, data files, data structures, or the like. The programmed commands recorded to the non-transitory computer-readable recording medium may be particularly designed or configured for the disclosure or may be well known to one of ordinary skill in the art. Examples of the non-transitory computer-readable recording medium include magnetic media including hard disks, magnetic tapes, and floppy disks, optical media including CD-ROMs, and DVDs, magneto-optical media including floptical disks, and a hardware apparatus designed to store and execute the programmed commands in read-only memory (ROM), random-access memory (RAM), flash memories, and the like. Examples of the programmed commands include not only machine codes generated by a compiler but also include great codes to be executed in a computer by using an interpreter.

The apparatuses according to one or more exemplary embodiments may include a processor, a memory for storing and executing program data, a permanent storage including a disk drive, a communication port for communication with an external device, a user interface device including a touch panel, a key, a button, and the like. The methods embodied as a software module or an algorithm may be stored as computer-readable codes or program commands that are executable on the processor in a non-transitory computer-readable recording medium. The non-transitory computer-readable recording medium is any data storage device that can store data which can be thereafter read by a computer system. Examples of the non-transitory computer-readable recording medium include magnetic storage mediums (e.g., ROMs, RAMs, floppy disks, hard disks, etc) and optical reading mediums including CD-ROMs, DVDs, etc. The non-transitory computer-readable recording medium can also be distributed over network-coupled computer systems so that the computer-readable code is stored and executed in a distributed fashion. The mediums can be read by computers, can be stored in the memory, and can be executed on the processor.

Reference numerals have been made in the drawings, and specific language has been used to describe one or more exemplary embodiments. However, no limitation of the scope of the disclosure is intended by this specific language, and the disclosure should be construed to encompass all exemplary embodiments that would normally occur to one of ordinary skill in the art.

Exemplary embodiments may be described in terms of functional block components and various processing steps. Such functional blocks may be realized by any number of hardware and/or software components configured to perform the specified functions. For example, one or more exemplary embodiments may employ various integrated circuit components, e.g., memory elements, processing elements, logic elements, look-up tables, and the like, which may carry out a variety of functions under the control of one or more microprocessors or other control devices. Exemplary embodiments may employ same or different types of cores and different types of CPUs. Similarly, where the elements of the disclosure are implemented using software programming or software elements, the disclosure may be implemented with any programming or scripting language such as C, C++, Java, assembler, or the like, with the various algorithms being implemented with any combination of data structures, objects, processes, routines or other programming elements. Furthermore, one or more exemplary embodiments could employ any number of conventional techniques for electronics configuration, signal processing and/or control, data processing and the like. The words “mechanism”, “element”, “means”, or “configuration” may be used broadly and is not limited to mechanical or physical embodiments, but can include software routines in conjunction with processors, etc.

The particular implementations shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as “essential”, “critical”, and the like.

The use of the terms “a” and “an” and “the” and similar referents in the context of describing one or more exemplary embodiments are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate one or more exemplary embodiments and does not pose a limitation on the scope of the disclosure unless otherwise claimed. Numerous modifications and adaptations will be readily apparent to one of ordinary skill in this art without departing from the spirit and scope of the disclosure.

What is claimed is:

1. A method of controlling a device that provides content, the method comprising:
receiving a control signal for controlling at least one item of content provided by the device;
in response to receiving the control signal, capturing a screen of the device at preset intervals;
in response to the captured screen corresponding to a template screen, extracting content information from a preset area of the captured screen; and
identifying content displayed on the screen of the device, based on the extracted content information.

2. The method of claim 1, further comprising:
determining a service that provides the at least one item of content to the device; and
selecting the template screen, according to the determined service.

3. The method of claim 1, wherein the preset area of the captured screen corresponds to a content information display area set in the template screen.

4. The method of claim 1, further comprising, in response to the captured screen corresponding to the template screen, stopping the capturing of the screen on which the content is displayed.

5. The method of claim 1, wherein the identifying of the content comprises obtaining identification information of the content from the extracted content information by comparing the extracted content information with a pre-stored keyword.

6. The method of claim 1, further comprising:
determining a service that provides the at least one item of content; and
determining a type of the control signal,
wherein the capturing of the screen comprises capturing the screen on which the content is displayed according to the determined service and the determined type of the control signal.

7. The method of claim 1, wherein the control signal is at least one from among a channel change signal, a power-on signal, a signal for connecting the device with another device, and a signal for requesting information regarding the at least one item of content.

8. The method of claim 1, further comprising transmitting the extracted content information to a server.

9. The method of claim 8, further comprising receiving a content watching pattern of a user of the device from the server, wherein the content watching pattern is determined based on the extracted content information.

10. A non-transitory computer-readable recording medium having recorded thereon a program for executing the method of claim 1.

11. A device that provides content information, the device comprising:
a communication interface configured to receive a control signal for controlling at least one item of content provided by the device;
a display configured to display content on the device; and
a controller configured to:
in response to the communication interface receiving the control signal, capture a screen of the device at preset intervals; and
in response to the captured screen corresponding to a template screen, extract content information from a preset area of the captured screen; and
identify the content displayed on the display, based on the extracted content information.

12. The device of claim 11, wherein the controller is further configured to:
determine a service that provides the at least one item of content to the device, and
select the template screen according to the determined service.

13. The device of claim 11, wherein the preset area of the captured screen corresponds to a content information display area set in the template screen.

14. The device of claim 11, wherein the controller is further configured to, in response to the captured screen corresponding to the template screen, stop the capturing of the screen on which the content is displayed.

15. The device of claim 11, wherein the controller is further configured to obtain identification information of the content from the extracted content information by comparing the extracted content information with a pre-stored keyword.

16. The device of claim 11, wherein the controller is further configured to:
determine a service that provides the at least one item of content;
determine a type of the control signal; and
capture the screen on which the content is displayed according to the determined service and the determined type of the control signal.

17. The device of claim 11, wherein the control signal is at least one from among a channel change signal, a power-on signal, a signal for connecting the device with another device, and a signal for requesting information regarding the at least one item of content.

18. The device of claim 11, wherein the communication interface is further configured to transmit the extracted content information to a server.

19. The device of claim 18, wherein the communication interface is further configured to receive a content watching pattern of a user of the device from the server, and
wherein the content watching pattern is determined based on the extracted content information.
